(19) United States
(12) Patent Application Publication
(10) Pub. No.: US 2004/0140987 A1
(43) Pub. Date: Jul. 22, 2004

(54) Process for controlling out of box experience customization

(76) Inventors: James A. Howell JR., Georgetown, TX (US); Shree Dandekar, Austin, TX (US)

Correspondence Address: HAMILTON & TERRILE, LLP, P.O. BOX 203518, AUSTIN, TX, 78720, US

(21) Appl. No.: 10/346,523

(22) Filed: Jan. 17, 2003

(51) Int. Cl. G09G 5/00

(52) U.S. Cl. 345/700

(57) ABSTRACT

A method of providing a customized out of box experience for an information handling system. The method includes configuring an information handling system with options selected according to user input and presenting a customized out of box experience when the information handling system is initially started by a user based upon selected service options. The options selected include service options. The configuring includes customizing an out of box presentation based upon selected service options.

### BACKGROUND OF THE INVENTION

1. Field of the Invention

The present invention relates to build to order systems, and more particularly, to services controlling the out of box experience for build to order systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A first generation web based on-line store provided a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart,” wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout,” the checkout including essentially a form for facilitating the capture of requested and required information. The checkout form included simple logic rules to assure entry of the required fields.

After a system is ordered, the customer may be provided the opportunity to order a particular service such as Internet service. When the customer indicates a desire to order such a service, then the on-line store transfers (i.e., links) the customer to the web site for the particular service in which the customer is interested. Often the web site for the service provides its own look and feel, different from the look and feel of the on-line store. Also, the customer experience changes with the link to the web site of the service provided. Also, after the customer has transferred to the new web site, the original on-line store no longer has control or can access the information provided by the customer.

Microsoft provides mechanisms for adding ISP's to their standard out of box experience but does not provide standard processes for customizing the out of box experience outside of branding or the manual adding/removing standard pages.

### SUMMARY OF THE INVENTION

In accordance with the present invention, customizing an out of box experience based upon services selected by a customer during the configuration of an information handling system advantageously provides the customer with a user friendly and specific out of box experience.

In one embodiment, the invention relates to a method of providing a customized out of box experience for an information handling system. The method includes configuring an information handling system with options selected according to user input and presenting a customized out of box experience when the information handling system is initially started by a user based upon selected service options. The options selected include service options. The configuring includes customizing an out of box presentation based upon selected service options.

In another embodiment, the invention relates to a method of controlling an out of box experience for an information handling system. The method includes storing out of box experience files on the information handling system based upon an information handling system part number, and using the part number to control screen presentations during an out of box. The information handling system part number is based upon services ordered during configuration of the information handling system.

In another embodiment, the invention relates to a method of controlling an out of box experience for an information handling system. The information handling system includes out of box experience files on the information handling system based upon an information handling system part number, the information handling system part number being based upon services ordered during configuration of the information handling system. The method includes using the part number to identify screen presentations to present during an out of box presentation of the information handling system, and presenting the screen presentations identified based upon the part number.

In another embodiment, the invention relates to an information handling system which includes a processor, memory coupled to the processor, means for configuring an information handling system with options selected according to user input and means for presenting a customized out of box experience when the information handling system is initially started by a user based upon service options selected when configuring the information handling system. The options selected include service options.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a flow chart for customizing an out of box experience based on part number.

FIG. 5 shows a flow chart for an out of box experience for a customized services configuration.

FIG. 6 shows an example of a screen presentation of a customized out of box experience function.

FIGS. 7-9 show examples of screen presentations of a customized out of box experience function when certain buttons are actuated.

### DETAILED DESCRIPTION

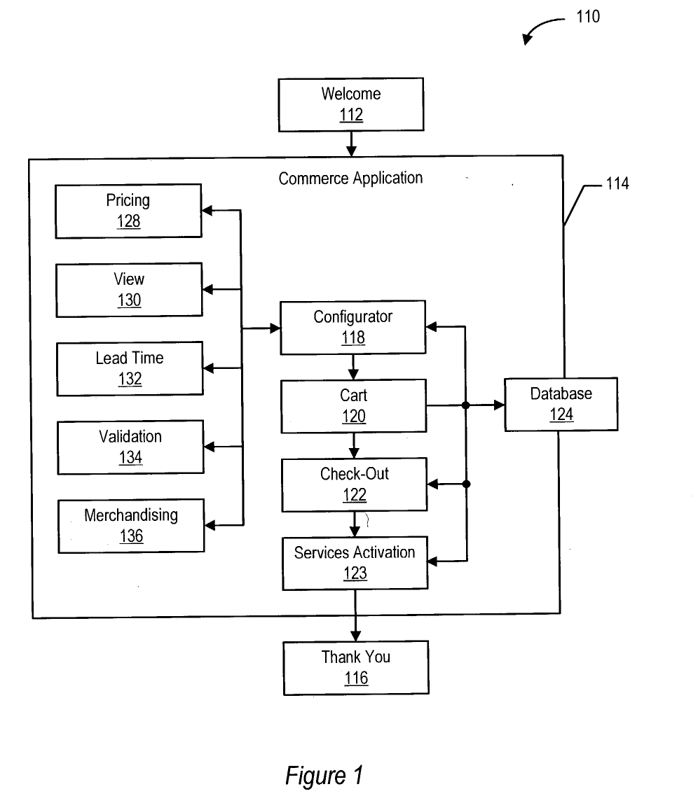

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the services activation module 123 presents a services activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a services activation page in which the customer is provided an opportunity to activate various services such as internet service or content services such as music services. After completion of the services activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and services activation module 123 are each part of the commerce application 114 and interact with the database 124. For example, with the shopping cart 120, additional merchandising information associated with a particular system which has been configured and placed in the shopping cart by an on-line store customer can be provided.

Also for example, various services may be provided for order by the customer by the services activation module 123 based upon the type of system ordered as well as components that are included within the system ordered. Additionally, by providing the services activation module within the commerce application 114, the customer continues the experience a similar customer experience and the system provider is able to use the information from the database 124 and to maintain control over the customer contact. By maintaining control over the customer contact the system provider is able to determine what services are activated and to maintain accurate and up to date records of the service activation.

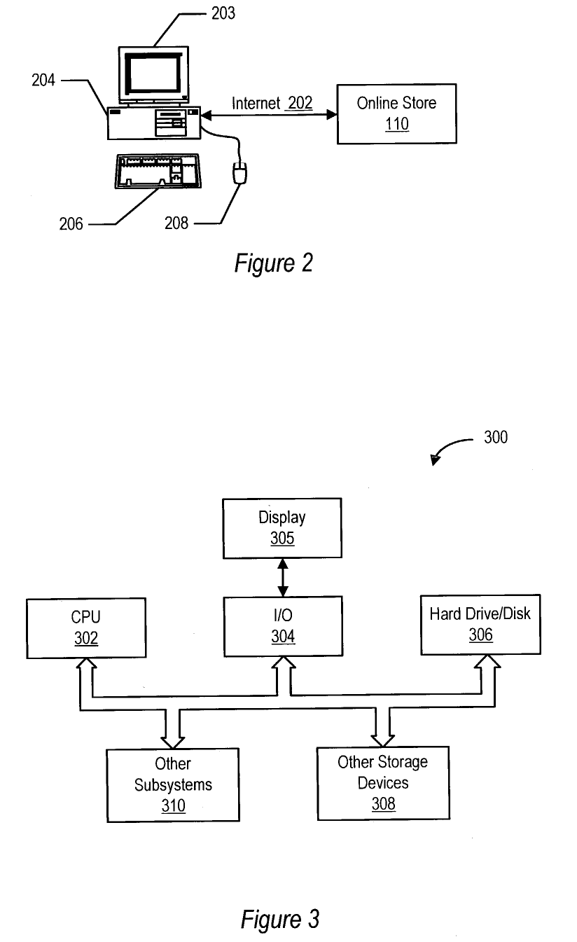

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

Referring briefly to FIG. 3, a system block diagram of an information handling system 300 is shown having features thereof configured in accordance with the on-line store 110 as discussed herein. The information handling system 300 includes a processor 302, input/output (I/O) devices, such as a display, a keyboard, a mouse, and associated controllers, collectively designed by a reference numeral 304, a hard disk and drive 306, and other storage devices, such as a floppy disk and drive and other memory devices, collectively designated by a reference numeral 308, and various other subsystems, collectively designated by a reference numeral 310, all interconnected via one or more buses, shown collectively as a bus 312.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

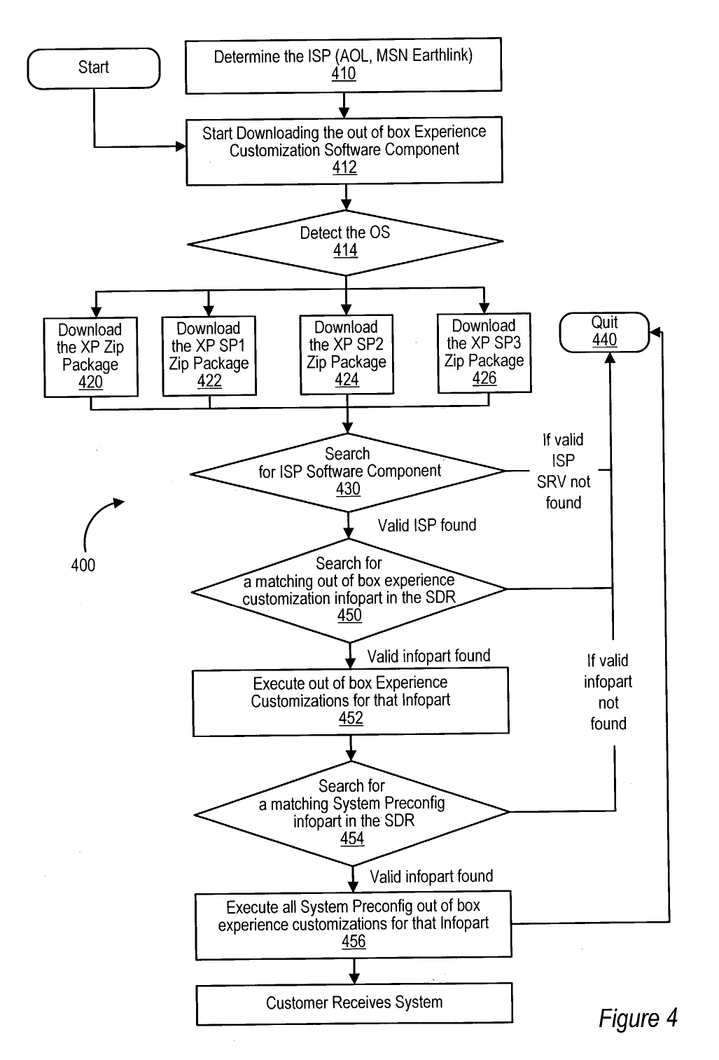

FIG. 4 shows a flow chart of a system 400 for controlling an out of box experience based on part number. In general, the system executes a program during factory download that places customized out of box experience files on the information handling system 300 based on information part numbers. The customized out of box experience files use the same part numbers to control what is displayed during an out of box experience. For example, if a customer has selected MSN as their ISP of choice, text on the ISP screen presentations during the out of box experience indicates that selection. The out of box customization experience system also detects the version of the operating system (for example, XP or XP SP 1) and based upon the operating system determines which out of box experience pages to display and which control file is appropriate for the particular operating system. Additionally, which providers and the order in which the providers are presented is varied depending on the information part numbers and software component detection. Such a system allows a manufacturer to have flexibility in adding or modifying out of box experience flow and content.

More specifically, when installing a customized out of box experience onto the information handling system 300, the out of box customizing system 400 determines whether and which ISP has been selected by accessing a system definition record at step 410. Once the ISP service provider has been determined, then the installer executes an out of box experience customization software component program at step 412. The program detects which operating system is loaded on the information handling system 300 at step 414. Based upon which operating system is loaded on the information handling system 300, the system 400 downloads an appropriate out of box experience customization package such as an XP zip package 420, an XP service pack 1 zip package 422, an XP service pack 2 zip package 424 or an XP service pack 3 zip package 426. Other operating systems and out of box experience customizations may be used as appropriate.

After the appropriate out of box experience customization is loaded onto the information handling system, the system 400 searches for the ISP system definition record in the software component file at step 430. If a valid ISP system definition record is not found, then the system 400 quits at step 440. After a valid ISP system definition record is detected, then the system 400 searches for a matching out of box experience customization information part number (infopart) within a software component file at step 450.

When pre-paid goods, services, or benefits have been purchased, a product code is installed on the information handling system 300 when the system is manufactured. The product code is inserted into the system definition record. The product code is a code that corresponds to the particular pre-paid item that has been identified as having been purchased by the purchaser. The system definition record is a hidden text file bearing the extension SDR. The system definition record is a log file created at the factory to store certain information, such as the product code. In an alternative embodiment, this information may instead be stored directly to the Basic Input/Output System (BIOS) area of the information handling system 300. If a valid information part number is not found, then the program quits at step 440.

If a valid information part number is found, then the program executes all out of box experience customizations for the information part number at step 452. Examples of customizations that may be executed as part of the out of box experience include the length of a promotion offer, whether to present the option of a full benefit registration and whether to present information pertaining to a benefit (via, e.g., a splash screen presentation).

After the customizations have been executed, then the program searches for a matching system pre-configuration information part number within the system definition record at step 454. If a valid system pre-configuration information part number is not found, then the program quits at step 440. If a valid system pre-configuration information part number is found, then the program executes system pre-configuration out of box experience customizations for the corresponding system pre-configuration information part number at step 456. Examples of system pre-configuration customizations include indicating that the registration was completed at point of sale (i.e., during the configuration of the information handling system) and displaying specific information on how to use a benefit that was obtained at the point of sale registration. After the system pre-configuration step 456 completes executing, then the program completes executing and quits at step 440.

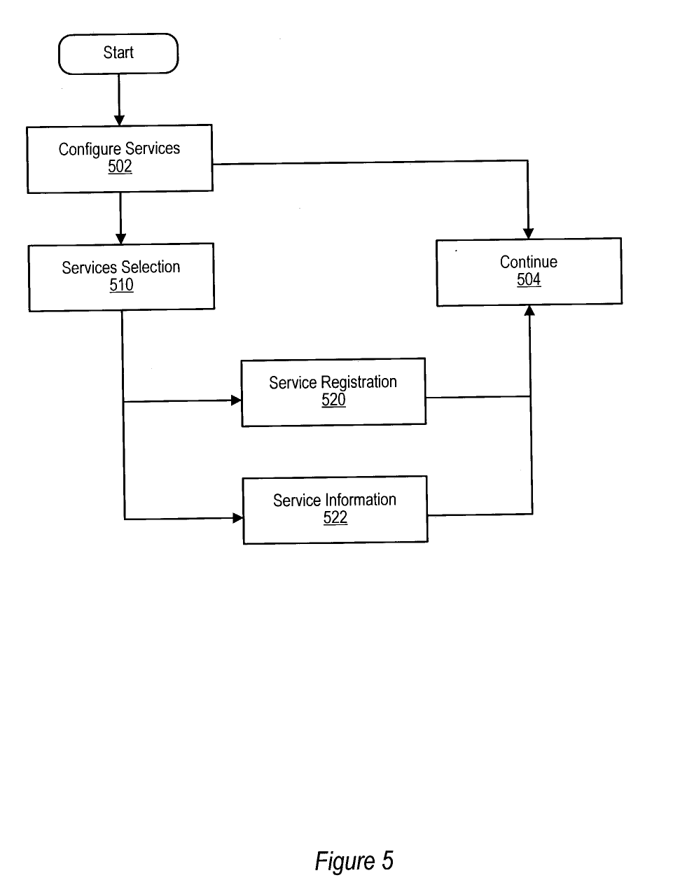

Referring to FIG. 5, a flow chart for an out of box experience flow having customized services configuration is shown. More specifically, when the out of box experience starts, the system determines whether a user wishes to configure a benefit such as services at step 502. If not, then the operation of the out of box experience continues at step 504.

If a user wishes to configure services, then the out of box experience provides a customized services selection based upon part number at step 510. The list of services selection is based upon part number customizations as installed during the configuration process.

Based upon a user selection, the services selection may be a full services registration process as set forth at step 520 or a service information presentation as set forth at step 522. The service information presentation may be, e.g., a splash screen. After either the service registration process at step 520 or the service information presentation at step 522, the out of box experience continues at step 504.

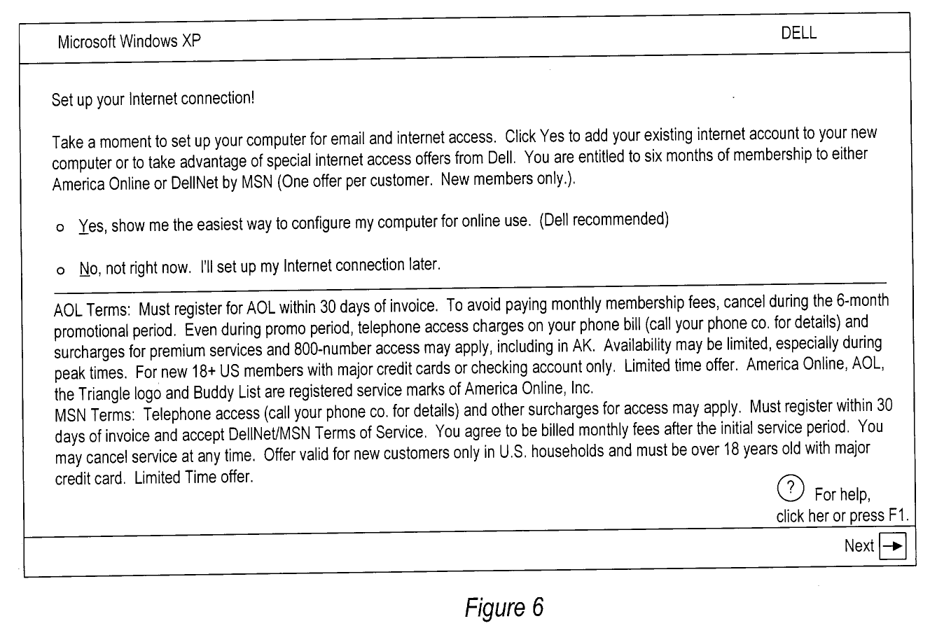

Referring to FIG. 6, a screen presentation of a customized out of box experience set up function is shown. More specifically, when the out of box experience program starts executing, the program generates a screen presentation to enable a customer to set up certain services, such as, e.g., an internet connection. The particular screen presentation that is presented depends upon whether any services were selected during the configuration of the information handling system 300. For example, if a user did not select any internet connection, then the presentation set forth in FIG. 6 queries a customer about whether the customer would like to easily configure an internet connection or whether the customer would like to configure an internet connection at a later time. This customization may also vary the length of service membership to which the user is entitled based upon the out of box experience customization.

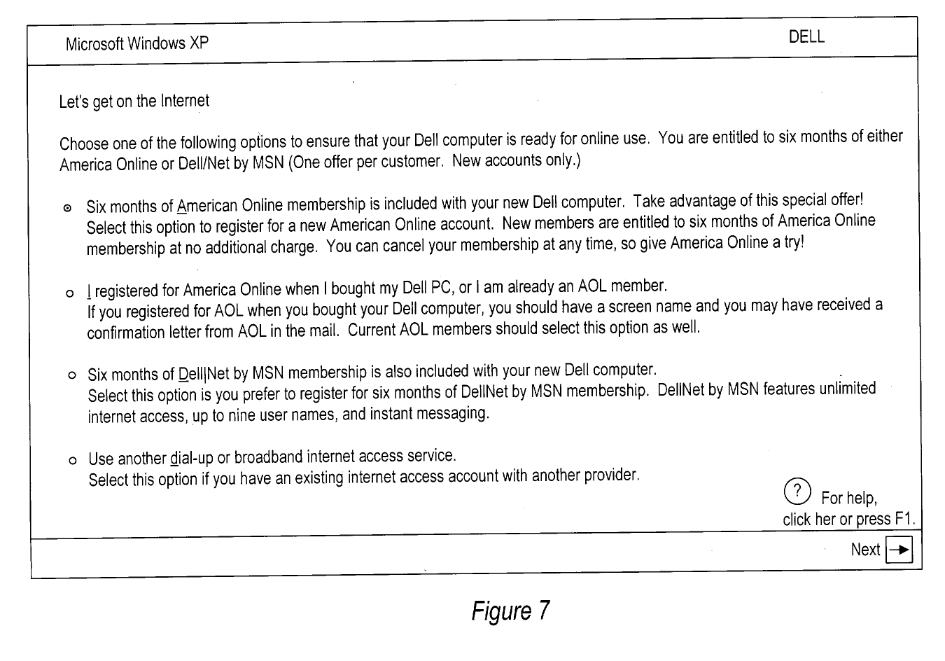

If the customer indicates the desire to configure an internet connection, then the screen presentation set forth in FIG. 7 is presented. Which (if any) services were selected during the configuration of the information handling system 300, determines which options are provided to the customer and whether any particular options are initially actuated by the program when the screen is presented. For example, if the customer had registered for America Online during the configuration of the information handling system 300, then that option is pre-actuated when the screen is presented. The default, if no services were selected during the configuration of the information handling system 300, is to provide the customer with an initial membership offer.

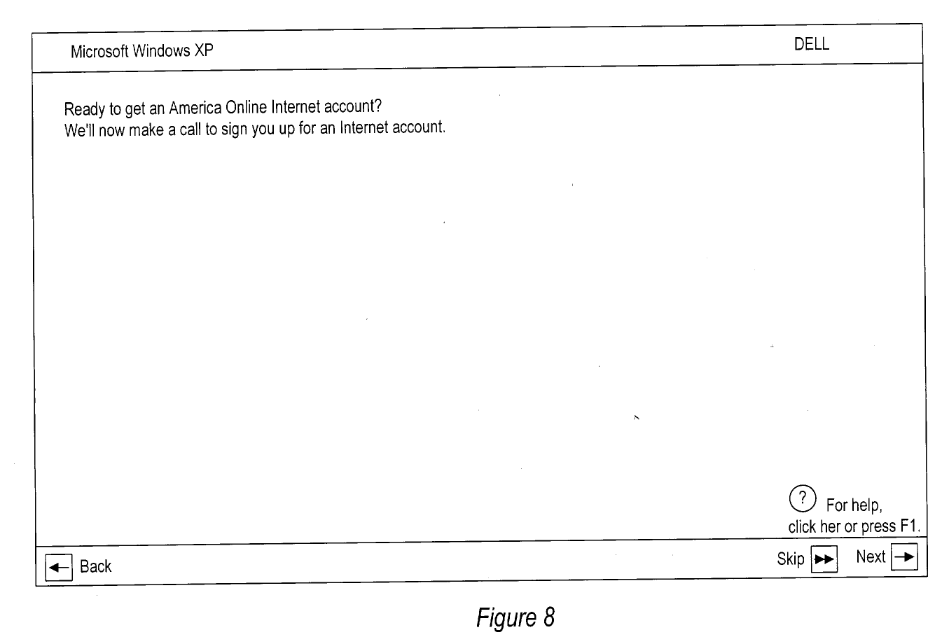

Once an option is selected, the customer actuates the “next” button and the out of box experience program presents the next screen presentation. For example, FIG. 8 shows the screen presentation that is generated if a user indicates a desire to activate an American Online membership during the services activation screen presentation. This screen presentation alerts the customer that the program is going to sign the customer up for an internet account.

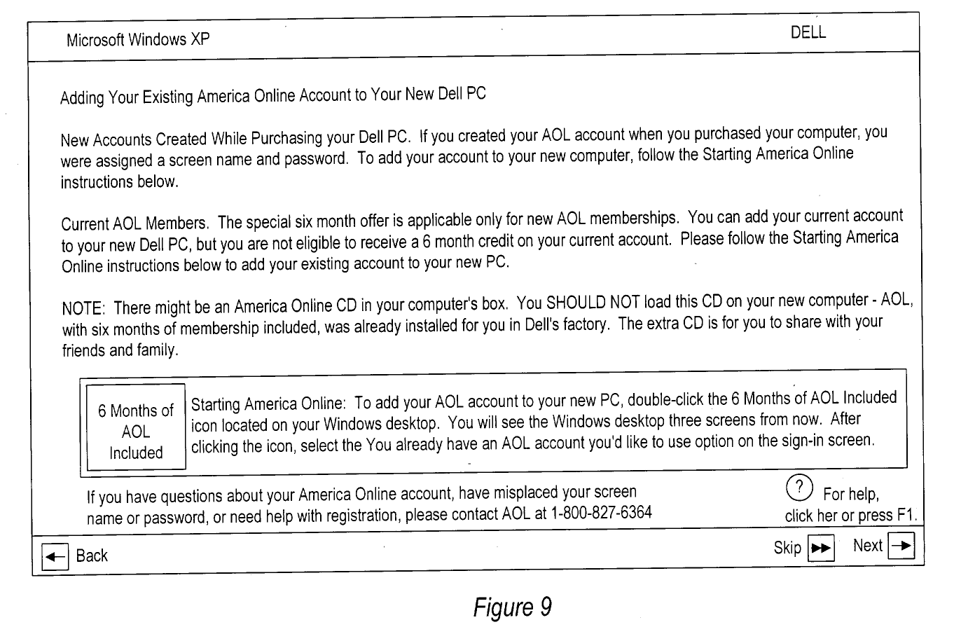

FIG. 9 shows a screen presentation that is generated if the user indicated a preexisting membership to a service during the services activation screen presentation. This screen presentation starts the process of showing the customer how to add an existing internet account to the computer system. This type of screen presentation is a splash screen presentation as the presentation is merely providing information without any actual selections necessary.

Other Embodiments

Other embodiments are within the following claims.

For example, the services activation module 123 which interacts with the database 124 may be used by a telephone sales person when a system is being ordered via the telephone. In this situation, the information that is derived by the telephone sale person during a customer interview is then used to provide the customer with the option of services activation. Accordingly, the customer continues the experience a similar customer experience and the system provider is able to use the information from its database and to maintain control over the customer contact. By maintaining control over the customer contact the system provider is able to determine what services are activated and to maintain accurate and up to date records of the service activation.

Also for example, while specific services are identified as being activated by the services activation module, other services or benefits may also be activated by the services activation module.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method of providing a customized out of box experience for an information handling system comprising:
configuring an information handling system with options selected according to user input, the options selected including service options, the configuring including customizing an out of box presentation based upon selected service options; and
presenting a customized out of box experience when the information handling system is initially started by a user based upon selected service options.

2. The method of claim 1 further comprising
providing the customer with a consistent customer experience during the out of box experience.

3. The method of claim 1 wherein
the presenting allows a user to activate services based upon the options selected during the configuring.

4. The method of claim 1 further comprising
detecting an operating system version during the configuring of the information handling system.

5. The method of claim 1 further comprising
determining which out of box experience screen presentations to present based upon the operating system version.

6. The method of claim 1 wherein
the services ordered include internet services.

7. The method of claim 6 wherein
whether certain providers are presented during the out of box presentation is determined based upon the services ordered.

8. The method of claim 6 wherein
an order of presentation of providers during the out of box presentation is determined based upon the services ordered.

9. A method of controlling an out of box experience for an information handling system comprising:
storing out of box experience files on the information handling system based upon an information handling system part number, the information handling system part number being based upon services ordered during configuration of the information handling system;
using the part number to control screen presentations during an out of box presentation of the information handling system.

10. The method of claim 9 further comprising
detecting an operating system version during the during the configuring of the information handling system.

11. The method of claim 10 further comprising
determining which out of box experience screen presentations to present based upon the information handling system.

12. The method of claim 9 wherein
the services ordered include internet services.

13. The method of claim 12 wherein
whether certain providers are presented during the out of box presentation is determined based upon the services ordered.

14. The method of claim 12 wherein
an order of presentation of providers during the out of box presentation is determined based upon the services ordered.

15. A method of controlling an out of box experience for an information handling system, the information handling system including out of box experience files on the information handling system based upon an information handling system part number, the information handling system part number being based upon services ordered during configuration of the information handling system, the method comprising:
using the part number to identify screen presentations to present during an out of box presentation of the information handling system; and,
presenting the screen presentations identified based upon the part number.

16. The method of claim 15 further comprising
determining which out of box experience screen presentations to present based upon the information handling system.

17. The method of claim 15 wherein
the services ordered include internet services.

18. The method of claim 13 wherein
whether certain providers are presented during the out of box presentation is determined based upon the services ordered.

19. The method of claim 18 wherein
an order of presentation of providers during the out of box presentation is determined based upon the services ordered.

20. An information handling system comprising:
a processor;
memory coupled to the processor;
means for configuring an information handling system with options selected according to user input, the options selected including service options; and
means for presenting a customized out of box experience when the information handling system is initially started by a user based upon service options selected when configuring the information handling system.
